(19) United States
(12) Patent Application Publication
(10) Pub. No.: US 2007/0273873 A1
(43) Pub. Date: Nov. 29, 2007

(54) Object Inspection Machine

(76) Inventor: Ming-Liau YANG, Gangshan Township (TW)

Correspondence Address: BANGER SHIA, 204 CANYON CREEK, VICTORIA, TX, 77901, US

(21) Appl. No.: 11/552,954

(22) Filed: Oct. 25, 2006

(30) Foreign Application Priority Data
May 29, 2006 (TW) 095209303

(51) Int. Cl. G01N 21/89; G01N 21/01

(52) U.S. Cl. 356/237.1

(57) ABSTRACT

An object inspection machine comprises one or more engaging units and one or more sustaining units on the turnplate of the nip device. With the sustaining unit and the engaging unit engaging to each other, an object can be nipped and rotated. The camera thus designed is capable of taking a whole image of various sides of the object, and thereby increasing the accuracy of inspection.

### BACKGROUND OF THE INVENTION

1. Field of the Invention

The present invention relates to an inspection machine. In particular, it relates to an object inspection machine with great inspecting accuracy.

2. Description of the Related Art

Referring to FIG. 1, a conventional screw inspection machine 1 comprises a feeding device 11, a rotatable wheel 12 collecting the screws 2 shipped out from the feeding device 11, a camera 13 disposed beside the rotatable wheel 12, and a calculator 14 connecting with the camera 13; wherein, a plurality of grooves 121 are disposed around the periphery of the rotatable wheel 12 for coupling with the screws 2. The camera 13 first takes the images of the screws 2, and the calculator 14 then analyzes and processes the aforesaid images.

While in operation, the feeding device 11 first pushes the screws 2 out, and the rotatable wheel 12 rotates the screws 2 to the camera 13, the camera 13 then takes the images of the screws 2 and sends the images to the calculator 14 for image analysis and filtering. With the outcome of the image analysis and filtering by the calculator 14, it can be decided whether the screws 2 meet with the required standards and be selected as qualified screws. Since the camera 13 only takes the images of one side of the screws 2, possible defects on the other side of the screws 2 will not be visible in the images taken. Therefore, there is still room for improvements in the inspecting quality of the conventional screw inspection machine 1.

### SUMMARY OF THE INVENTION

It is therefore the purpose of this invention to provide an object inspection machine with better inspecting quality and greater inspecting accuracy.

The present invention has a nip device disposed beside the rotatable wheel. Said nip device consists of a turnplate set beside the grooves, and one or more sustaining unit and one or more engaging unit disposed on the turnplate; wherein, said turnplate is composed of a turning pillar, a first plate, and a second plate. Both said first plate and said second plate extend from said turning pillar. To be more specific, said first plate is set above said rotatable wheel to allow said sustaining unit disposed thereon, and said second plate is set below said rotatable wheel to allow said engaging unit disposed thereon. While in operation, each said sustaining unit and its collinear engaging unit rotate the object. Therefore, said camera can take the images of various sides of the whole object. Said calculator will then have more data for processing, and hence will increase the inspecting accuracy.

The advantages of the present invention over the known prior arts will become more apparent to those of ordinary skilled in the art upon reading the following descriptions in conjunction with the accompanying drawings.

### BRIEF DESCRIPTION OF THE DRAWINGS

FIG. 1 is a perspective view illustrating an object inspection machine (a screw inspection machine is illustrated in the figures as an example);

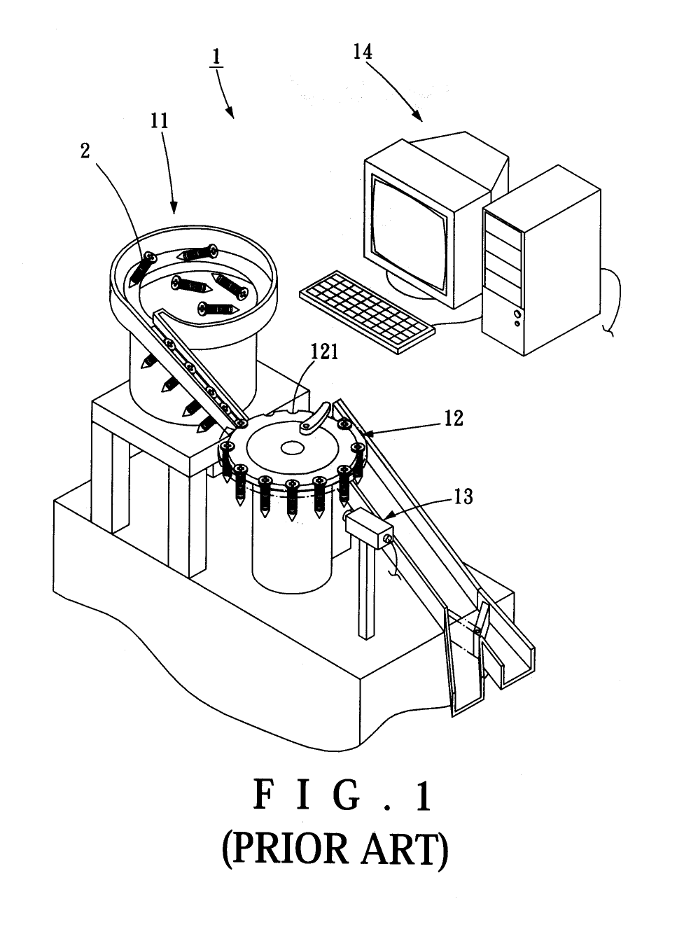

FIG. 2 is a perspective view of a preferred embodiment of the present invention;

FIG. 3 is a partial perspective view illustrating a preferred embodiment; and

FIG. 4 is another partial perspective view illustrating the preferred embodiment.

### DETAILED DESCRIPTION OF THE PREFERRED EMBODIMENTS

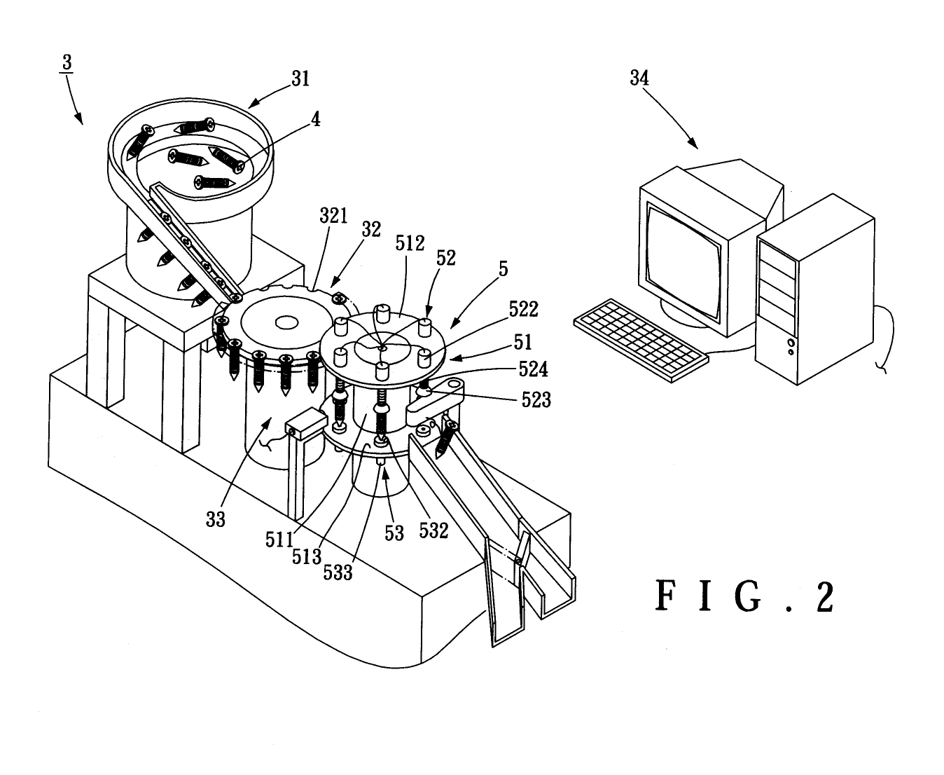

Referring to FIG. 2, the preferred embodiment of an object inspection machine 3 comprises a feeding device 31, a rotatable wheel 32 collecting the objects shipped out from the feeding device 31, a camera 33 disposed beside the rotatable wheel 32, and a calculator 34 connecting with the camera 33; wherein, said objects can be screws, or nuts, etc. In the present description, the screws 4 are taken as an example. Furthermore, a plurality of grooves 321 are disposed around the periphery of the rotatable wheel 32. While in operation, the camera 33 first takes the images of the screws 4, and the calculator 34 then analyzes and processes the aforesaid images taken.

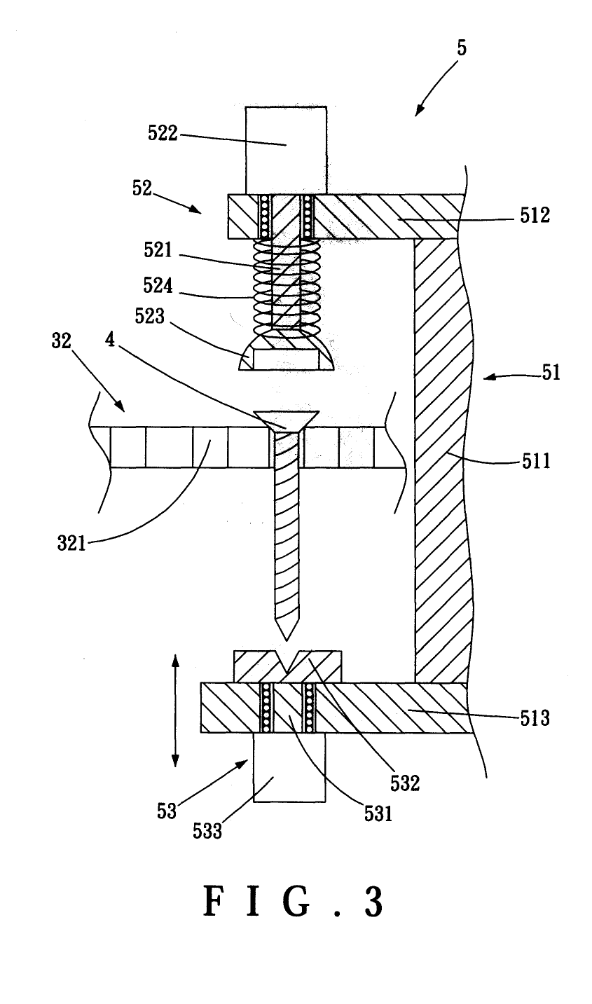

Referring to FIG. 3, a nip device 5 disposed beside the rotatable wheel 32 has a turnplate 51 set beside the grooves 321; wherein, the turnplate 51 is composed of a turning pillar 511, a first plate 512 and a second plate 513. The first plate 512 and the second plate 513 both extend from the turning pillar 511. To be more specific, the first plate 512 is set above the rotatable wheel 32 to allow at least one sustaining unit 52 disposed thereon, and the second plate 513 is set below the rotatable wheel 32 to allow at least one engaging unit 53 disposed thereon. Moreover, each sustaining unit 52 is composed of a bracket 521 pivotally coupled with the first plate 512, a power source 522 rotating the bracket 521, an upside mold 523 disposed on the bracket 521, and an elastic unit 524 set through the upside mold 523 and the first plate 512. Here the power source 522 is represented by a motor, and the elastic unit 524 is represented by a spring. Furthermore, each engaging unit 53 is composed of an engaging shelf 531 pivotally coupled with the second plate 513 and being collinear with the bracket 521, a downside mold 532 disposed on the engaging shelf 531, and a transmission device 533 pushing the engaging shelf 531 upward. The transmission device 533 can be a cam, or a hydraulic cylinder, etc., and a hydraulic cylinder is used as the transmission device 533 in this preferred embodiment.

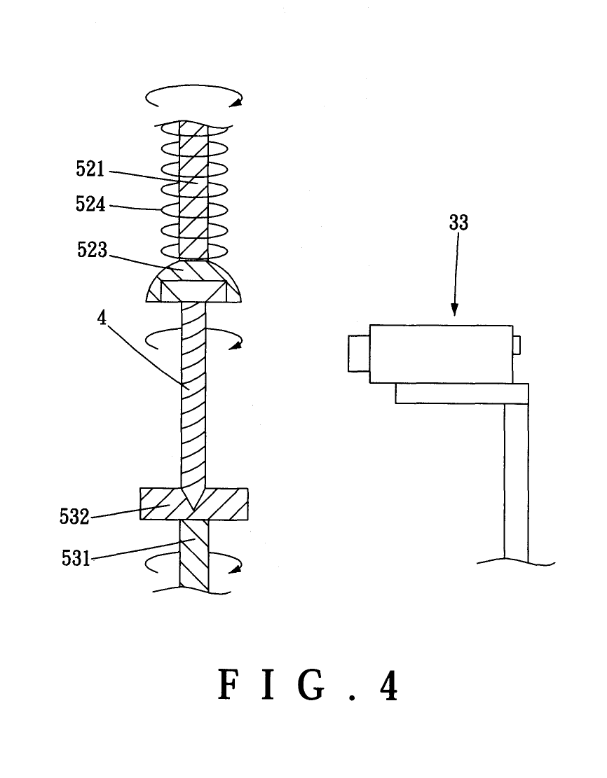

Referring to FIG. 2 and FIG. 3, while in operation, the feeding device 31 pushes the screws 4 out one by one and puts them on the grooves 321 of the rotatable wheel 32. The rotatable wheel 32 then rotates. Then, the transmission device 533 moves the engaging shelf 531 upward to make the downside mold 532 push the bottom of the screws 4, and at the same time the upside mold 523 also pushes the head of the screws 4 as shown in FIG. 4. Further with the support of the elastic unit 524, the screws 4 are stably held. Then the screws 4 are nipped out of the rotatable wheel 32 and are disposed at a position where the camera 33 faces With the bracket 521 rotated by the power source 522, the screws 4 are further rotated. The camera 33 therefore can take the images of each screw 4 at various sides. The images are then sent to the calculator 34 for analysis and processing to decide whether the screw 4 is qualified with the preset standards. Since the screw filtering process is based on abundant image data taken from various aspects of the screws being examined, the inspecting accuracy is enhanced significantly.

To sum up, the invention makes use of the sustaining unit and the engaging unit of the nip device to nip and hold the objects and further to rotate said objects; therefore, the camera is capable of taking images of the objects at various sides and the calculator therefore has more image data for filtering. As a result, the accuracy of object inspection will increase, and the quality of screws inspected will be enhanced, too.

While we have shown and described the embodiment in accordance with the present invention, it should be clear to those skilled in the art that further embodiments may be made without departing from the scope of the present invention.

I claim:

1. An object inspection machine comprising:
(I) a feeding device for shipping out objects;
(II) a rotatable wheel with a plurality of grooves disposed around the periphery for engaging said objects shipped out from said feeding device and with a nip device disposed beside said rotatable wheel, wherein said nip device comprises:
(A) a turnplate beside said grooves comprising:
a turning pillar,
a first plate extending from said turning pillar and located above said rotatable wheel for said sustaining unit to be disposed thereon, and
a second plate extending from said turning pillar and located below said rotatable wheel for said engaging unit to be disposed thereon;
(B) one or more sustaining units comprising:
a bracket for pivotal coupling,
a power source rotating said bracket,
an upside mold disposed on said bracket, and
an elastic unit set through said upside mold and said first plate;
(C) one or more engaging units disposed on said turnplate comprising:
an engaging shelf for pivotally coupling with said second plate and for being linear with said bracket,
a downside mold disposed on said engaging shelf, and
a transmission device for pushing said engaging shelf upward;
(III) a camera disposed beside said rotatable wheel for taking the images of said objects; and
(iv) a calculator connecting with said camera for analyzing and filtering said images taken.
